(19) United States
(12) Patent Application Publication
(10) Pub. No.: US 2026/0172950 A1
(43) Pub. Date: Jun. 18, 2026

(54) APPARATUS AND METHOD FOR BARRING A UE ACCESS IN A WIRELESS COMMUNICATION SYSTEM

(71) Applicant: Samsung Electronics Co., Ltd., Suwon-si, Gyeonggi-do (KR)

(72) Inventors: Chadi KHIRALLAH, Staines, Middlesex (GB); Jonas SEDIN, Staines, Middlesex (GB); Aby Kanneath ABRAHAM, Bangalore (IN)

(21) Appl. No.: 19/126,904

(22) PCT Filed: Oct. 16, 2023
(86) PCT No.: PCT/KR2023/015933

§ 371 Date: May 2, 2025

(30) Foreign Application Priority Data
Nov. 3, 2022 (IN) 202231062754
Sep. 29, 2023 (GB) 2315030.3

(51) Int. Cl. H04W 48/16; H04W 8/22; H04W 76/30; H04W 84/06

(52) U.S. Cl. CPC H04W 48/16; H04W 8/22; H04W 76/30; H04W 84/06

(57) ABSTRACT

The disclosure relates to a 5G or 6G communication system for supporting a higher data transmission rate. There is disclosed a method for restricting UE network access. The method comprises: determining whether a condition is satisfied, wherein the condition comprises one or more of: the UE does not support network verification of UE location information; and network verification of UE location information has failed. The method further comprises restricting the UE network access based on the determination. Restricting the UE network access may comprise one or more of: restricting UE access to the network entirely; restricting UE access to one or more certain PLMNs; restricting UE access to one or more certain types of PLMN (e.g. NTN PLMNs); restricting UE access to one or more certain cells; restricting UE access to one or more certain types of cell; and restricting UE access to one or more certain types of service (e.g. emergency services).

### TECHNICAL FIELD

Certain examples of the present disclosure provide one or more techniques for barring and/or rejecting UE access to a network cell. For example, certain examples of the present disclosure provide one or more techniques for barring and/or rejecting UE access to a network cell in a 3GPP 5G NR network based on UE location verification capabilities.

### BACKGROUND ART

5G (5th Generation) mobile communication technologies define broad frequency bands such that high transmission rates and new services are possible, and can be implemented not only in “Sub 6 GHz” bands such as 3.5 GHZ, but also in “Above 6 GHz” bands referred to as mmWave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also fullduplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultrahigh-performance communication and computing resources.

### DISCLOSURE OF INVENTION

### Solution to Problem

It is an aim of certain examples of the present disclosure to address, solve and/or mitigate, at least partly, at least one of the problems and/or disadvantages associated with the related art, for example at least one of the problems and/or disadvantages described herein. It is an aim of certain examples of the present disclosure to provide at least one advantage over the related art, for example at least one of the advantages described herein.

The present invention is defined in the independent claims. Advantageous features are defined in the dependent claims.

Embodiments or examples disclosed in the description and/or figures falling outside the scope of the claims are to be understood as examples useful for understanding the present invention.

Other aspects, advantages and salient features of the invention will become apparent to those skilled in the art from the following detailed description taken in conjunction with the accompanying drawings.

### Advantageous Effects of Invention

Aspects of the present disclosure provide an efficient communication methods in a wireless communication system.

### BRIEF DESCRIPTION OF DRAWINGS

FIG. 1 illustrates an exemplary technique for signalling the required UE positioning capability transparently in System Information;

FIG. 2 illustrates an exemplary technique for Connection release when gNB detects UE does not have the required UE positioning capabilities;

FIG. 3 illustrates an exemplary technique in which AMF receives information regarding UE capabilities and AMF initiates UE context release;

FIG. 4 illustrates an exemplary technique for signalling UE capabilities over LPP (from UE to LMF) and then rejecting the UE;

FIG. 5 is a block diagram of an exemplary network entity that may be used in certain examples of the present disclosure;

FIG. 6 illustrates a block diagram illustrating a structure of a UE according to an embodiment of the disclosure; and

FIG. 7 illustrates a block diagram illustrating a structure of a base station according to an embodiment of the disclosure.

### MODE FOR THE INVENTION

The following description of examples of the present disclosure, with reference to the accompanying drawings, is provided to assist in a comprehensive understanding of the present invention, as defined by the claims. The description includes various specific details to assist in that understanding but these are to be regarded as merely exemplary. Accordingly, those of ordinary skill in the art will recognize that various changes and modifications of the examples described herein can be made without departing from the scope of the invention.

The same or similar components may be designated by the same or similar reference numerals, although they may be illustrated in different drawings.

Detailed descriptions of techniques, structures, functions, operations or processes known in the art may be omitted for clarity and conciseness, and to avoid obscuring the subject matter of the present invention.

The terms and words used herein are not limited to the bibliographical or standard meanings, but, are merely used to enable a clear and consistent understanding of the invention.

Throughout the description and claims of this specification, the words “comprise”, “include” and “contain” and variations of the words, for example “comprising” and “comprises”, means “including but not limited to”, and is not intended to (and does not) exclude other features, elements, components, integers, steps, processes, operations, functions, characteristics, properties and/or groups thereof.

Throughout the description and claims of this specification, the singular form, for example “a”, “an” and “the”, encompasses the plural unless the context otherwise requires. For example, reference to “an object” includes reference to one or more of such objects.

Throughout the description and claims of this specification, language in the general form of “X for Y” (where Y is some action, process, operation, function, activity or step and X is some means for carrying out that action, process, operation, function, activity or step) encompasses means X adapted, configured or arranged specifically, but not necessarily exclusively, to do Y.

Features, elements, components, integers, steps, processes, operations, functions, characteristics, properties and/or groups thereof described or disclosed in conjunction with a particular aspect, embodiment, example or claim are to be understood to be applicable to any other aspect, embodiment, example or claim described herein unless incompatible therewith.

The skilled person will appreciate that the techniques described herein may be used in any suitable combination.

Certain examples of the present disclosure provide one or more techniques for barring and/or rejecting UE access to a network cell. For example, certain examples of the present disclosure provide one or more techniques for barring and/or rejecting UE access to a network cell in a 3GPP (3^{rd} Generation Partnership Project) 5G (5^{th} Generation) NR (new radio) network UE (user equipment) location verification capabilities. However, the skilled person will appreciate that the present invention is not limited to these examples, and may be applied in any suitable system or standard, for example one or more existing and/or future generation wireless communication systems or standards, including any existing or future releases of the same standards specification, for example 3GPP 5G.

The functionality of the various network entities and other features disclosed herein may be applied to corresponding or equivalent entities or features in the same or any other suitable communication systems or standards. Corresponding or equivalent entities or features may be regarded as entities or features that perform the same or similar role, function or purpose within the network. For example, the functionality of a NG-RAN (Radio Access Network) node (e.g. a base station, eNB (evolved node B) or gNB (5G node B)) in the examples below may be applied to any other suitable type of entity performing RAN functions.

A particular network entity may be implemented as a network element on a dedicated hardware, as a software instance running on a dedicated hardware, and/or as a virtualised function instantiated on an appropriate platform, e.g. on a cloud infrastructure.

The skilled person will appreciate that the present invention is not limited to the specific examples disclosed herein. For example:
The techniques disclosed herein are not limited to 3GPP 5G.
One or more entities in the examples disclosed herein may be replaced with one or more alternative entities performing equivalent or corresponding functions, processes or operations.
One or more of the messages in the examples disclosed herein may be replaced with one or more alternative messages, signals or other type of information carriers that communicate equivalent or corresponding information.
One or more further elements or entities may be added to the examples disclosed herein.
One or more non-essential elements or entities may be omitted in certain examples.
The functions, processes or operations of a particular entity in one example may be divided between two or more separate entities in an alternative example.
The functions, processes or operations of two or more separate entities in one example may be performed by a single entity in an alternative example.
Information carried by a particular message in one example may be carried by two or more separate messages in an alternative example.
Information carried by two or more separate messages in one example may be carried by a single message in an alternative example.
The order in which operations are performed and/or the order in which messages are transmitted may be modified, if possible, in alternative examples.

Certain examples of the present disclosure may be provided in the form of an apparatus/device/network entity configured to perform one or more defined network functions and/or a method therefor. Certain examples of the present disclosure may be provided in the form of a system (e.g. network or wireless communication system) comprising one or more such apparatuses/devices/network entities, and/or a method therefor.

One or more problems exist in the related art, including one or more of the following.

One of the areas currently under development in 3GPP 5G wireless technology is support for non-terrestrial networks (NTNs). An NTN is a network in which one or more nodes (e.g. a Next Generation Radio Access Network (NG-RAN) node) are provided by a non-terrestrial infrastructure, for example a satellite or High Altitude Platform Station (HAPS). Advantages of using an NTN include (i) extending coverage to regions, such as remote areas, with limited or no coverage from more traditional terrestrial networks, (ii) providing continuous coverage in the event of inoperability of traditional terrestrial networks, such as during natural disasters, and (iii) enhancing overall reliability, resilience and capacity when used in conjunction with existing terrestrial networks.

A satellite network implementing a network node provides coverage through one or more radio beams forming a “footprint” on the surface of the Earth defining a coverage area or cell. An NTN cell may be Earth-moving (i.e. moving over the Earth's surface according to the motion of the satellite, for example in the case of a Lower Earth Orbit (LEO) satellite), Earth-fixed (i.e. a fixed area of the Earth's surface, for example in the case of a Geosynchronous Equatorial Orbit (GEO) satellite) or quasi-Earth-fixed (i.e. a fixed area of the Earth's surface but is maintained for only a limited time as the satellite passes by).

IoT (Internet of Things) NTN was a 3GPP study and work item in 3GPP Release 17 to provide NTN access for E-UTRAN (Evolved Universal Terrestrial Radio Access Network) IoT devices (NB-IoT and LTE (Long Term Evolution)-M/eMTC (enhanced Machine Type Communication)) [RP-202689]. The work was parallel to the work on adapting 5G NR to NTN.

NR NTN (NR_NTN_solutions-Core) [RP-211557] was a 3GPP Work Item in 3GPP Release 17 to define solutions enabling New Radio (NR) and NG-RAN to support NTN. It addressed solutions for Transparent payload for both Geostationary and nonGeostationary network scenarios, with the UE having GNSS (Global Navigation Satellite System) capability and the satellite beams being Earth-fixed (or quasiEarth-fixed) or earth-moving.

NR NTN enhancements [RP-222654] is a 3GPP Work Item in 3GPP Release 18 aiming to enhance NR NTN with the following topics:

### Coverage Enhancements

Identifying and specifying potential issues and enhancements considering NTN characteristics
NR NTN deployment in above 10 GHz bands

NR NTN Release 17 did not have support for FR2 (Frequency Range 2) due to there being no PRACH (Physical Random Access Channel) format in FR2 for FDD (Frequency Division Duplex).
Network verified UE location
NTN-TN and NTN-NTN mobility and service continuity enhancements

Considers NTN-TN and NTN-NTN measurement/mobility and service continuity enhancements

In RAN #96 meeting, RAN started a new Rel-18 Study on requirements and use cases for network verified UE location for Non Terrestrial-Networks (NTN) in NR [RP-221820]. The outcome of the study is in the approved 3GPP TR 38.882. In the use cases part, the following is mentioned:

With NTN it is possible to deploy very large cells over large portions of a continent (possibly covering different countries), with the different core networks for the various countries connected to the same NTN RAN (MOCN (Multi-Operator Core Network) network sharing scenario). In such a scenario, it may not always be possible to correctly determine the appropriate core network for a connecting UE, especially close to country borders, because the serving cell information may not be granular enough.

Furthermore, a malicious UE might “fake” its selected PLMN (Public Land Mobile Network) in order to attempt connecting to a different core network. Upon such an attempt the AMF will disconnect the UE and inform the RAN node via an appropriate NGAP cause value, so the RAN can take appropriate action on subsequent attempts by the same UE.

The UE may send GNSS measurements to the RAN over RRC (Radio Resource Control), but this has at least the following drawbacks:
In principle, just as a malicious UE could fake its selected PLMN, it could also fake its GNSS measurements;
Sending GNSS measurements over RRC before AS (access stratum) security is set up raises security and privacy issues.

Because of the above, relying only on signalling GNSS measurements over RRC is not considered a viable solution to this issue.

### LTE Positioning Protocol (LPP)

LPP specifies many methods for performing and transferring position measurement [3GPP TS 37.355, “LTE Positioning Protocol (LPP)”, Release 17, V17.2.0, September 2022]. LPP specifies a number of different positioning methods:
OTDOA-Observed Time Difference of Arrival
A-GNSS-Assisted GNSS
E-CID-Enhanced Cell ID
Sensor
TBS-Terrestrial Beacon System
WLAN-Wireless LAN (Local Area Network)
Bluetooth
NR E-CID
NR DL-TDOA-NR Downlink Time Difference of Arrival
NR DL-AoD-Dowlink Angle of Departure
NR Multi-RTT (Round Trip Time)

The above information is presented as background information only to assist with an understanding of the present disclosure. No determination has been made, and no assertion is made, as to whether any of the above might be applicable as prior art with regard to the present invention.

In Release 18 NR NTN WI [RP-220953] the following is to be specified:
Study detailed regulatory requirement (e.g. accuracy, privacy, reliability, latency) for network-verified UE location for potential use cases/services (i.e. emergency call, lawful intercept, public warning, charging/billing) (at RAN plenary, from RAN #95 to RAN #96). [RAN]

Including further clarification on network verified UE location and its relationship to network-based positioning [RAN]

Study and evaluate, if needed, solutions for network to verify UE reported location information [RAN2, RAN1, RAN3]

In Rel-18 NR NTN, the UE GNSS position as indicated by the UE cannot be considered trusted, and thus mechanisms are needed to allow for the UE position to be verified. One of the main methods of determining the UE location is for the UE to perform measurements and send back the results to a network entity (e.g. RAN, Core Network, Location Server) or a network function. These measurements may be considered more trustworthy, for example because they may be more difficult to tamper with, and/or because tampering with the measurements may be more easy to detect, especially as the measurements needs to match the reported UE location.

However, problems with the above include (i) some network implementations may not trust the UEs deployed, and (ii) only one or a subset of the available positioning methods may be used by the network to verify the UE reported location information (or measurements), whereas a UE may not have implemented the corresponding location measurement features. This leads to a fragmentation, where a network may not want to serve certain UEs, or serve certain services to certain UEs.

Accordingly, certain examples of the present disclosure provide one or more techniques for handling UEs that do not have the capability or the network-preferred capability to support network verification of the UE reported location information. For example, certain examples of the present disclosure provide one or more techniques for selectively barring and/or rejecting UE access to some or all of a network and/or its corresponding services and/or procedures based on one or more criteria. The skilled person will appreciate that the various techniques disclosed herein may also be applied to selectively allowing and/or accepting UE access to some or all of a network and/or its corresponding services and/or procedures based on one or more criteria. Examples involving barring and/or rejecting may imply converse examples involving allowing and/or accepting.

In certain examples, the UE access barring and/or rejection (or UE access allowance and/or acceptance) may be with respect to (i) access to the network entirely, (ii) certain PLMNs or certain types of PLMN (e.g. NTN PLMN), (iii) certain services or types of services (e.g. on a PLMN), and/or (iv) any other suitable part of the network and/or its services. In certain examples, the UE access barring and/or rejection (or UE access allowance and/or acceptance) may be based on the UE's capabilities with respect to location information verification and/or whether a location information verification procedure has succeeded or failed.

In one example, a UE may be allowed to connect to an NTN cell if it does not have the capability (or capabilities) to support network verification of its location information, only if the UE is initiating an emergency call. In another example, only certain restricted services (e.g. limited bitrate services) may be allowed if UE location is not possible, for example if the UE capability with respect to location verification is not supported or not available.

Certain examples of the present disclosure provide a method for restricting UE network access, the method comprising: determining whether a condition is satisfied, wherein the condition comprises one or more of: the UE does not support network verification of UE location information; and network verification of UE location information has failed; and restricting the UE network access based on the determination.

In certain examples, restricting the UE network access may comprise one or more of: restricting UE access to the network entirely; restricting UE access to one or more certain PLMNs; restricting UE access to one or more certain types of PLMN (e.g. NTN PLMNs); restricting UE access to one or more certain cells; restricting UE access to one or more certain types of cell; and restricting UE access to one or more certain types of service (e.g. emergency services).

In certain examples, restricting the UE network access may comprise rejecting the UE by one or more of: a RAN entity; and a core network entity (e.g. AMF (Access and Mobility management Function)).

In certain examples, rejecting the UE may comprise rejecting the UE while trying to establish a connection with the RAN entity and/or the core network entity.

In certain examples, rejecting the UE may comprise releasing a connection of the UE with the RAN entity and/or the core network entity.

In certain examples, rejecting the UE may comprise one or more of: releasing, by the RAN entity, an RRC connection; triggering, by the RAN entity, a UE context release procedure; failing, by the core network entity, a NAS (Non Access Stratum) procedure (e.g. initial registration procedure and/or PDU (Protocol Data Unit) Session setup procedure); and releasing, by the core network entity, one or more PDU Sessions.

In certain examples, the method may further comprise signalling, by the UE and/or another network entity, UE capability with respect to network verification of UE location information.

In certain examples, the UE capability may be signalled to a RAN entity (e.g. gNB) and/or a core network entity (e.g. AMF, LMF (Location Management Function), other). In certain examples, the capability may be signalled from UE to a core network entity (e.g. AMF, LMF, other) and/or from a RAN entity (e.g. gNB) to a core network entity (e.g. AMF, LMF, other) (in each case either directly or via another network entity).

In certain examples, the UE may support network verification of UE location information if the UE supports one or more certain types of positioning method.

In certain examples, the network may be an NTN.

In certain examples, the operation of determining whether the condition is satisfied may be performed by one or more of: the UE; a RAN entity; and a core network entity.

In certain examples, the operation of restricting the UE network access based on the determination may be performed by one or more of: the UE; a RAN entity; and a core network entity.

Certain examples of the present disclosure provide a UE, RAN entity or core network entity configured to perform a method according to any example, embodiment, aspect and/or claim disclosed herein.

Certain examples of the present disclosure provide a network (or wireless communication system) comprising a UE, RAN entity and core network entity according to any examples, embodiments, aspects and/or claims disclosed herein.

Certain examples of the present disclosure provide a computer program comprising instructions which, when the program is executed by a computer or processor, cause the computer or processor to carry out a method according to any example, embodiment, aspect and/or claim disclosed herein.

Certain examples of the present disclosure provide a computer or processor-readable data carrier having stored thereon a computer program according to any example, embodiment, aspect and/or claim disclosed herein.

Certain non-limiting examples will now be described in more detail. These include (i) idle mode barring, in which the UE may be barred in idle mode, (ii) RAN-based rejection, in which RAN (e.g. gNB) may reject the UE, and (iii) core network-based rejection, in which the UE may be rejected by the core network.

The skilled person will appreciate that the techniques described herein may be applied to any suitable type of network, including NTN, terrestrial network, or a network comprising a mixture of NTN and terrestrial network.

The skilled person will also appreciate that the techniques described herein may be applied to any suitable type of device, including any suitable type of UE and/or any suitable type of IoT device.

The skilled person will also appreciate that the techniques described herein are applicable to various types of network entity, including eNB, gNB, E-UTRAN and/or NG-RAN node and related RRC signalling and/or messages, and/or suitable interface (e.g. X2, Xn (Interface between RAN nodes), S1 (Interface between RAN node and Core Network), NG, F1 (Interface between gNB CU and gNB DU)).

The skilled person will also appreciate that certain examples of the present disclosure may include one or more additional network entities and/or network functions not shown in the figures, for example Mobility Management Entity (MME), Mobility Management Function (AMF) and/or any other suitable type of network entity and/or network function, and related signalling and/or messages (e.g. NAS signalling and/or messages).

### 1. Idle Mode Barring

In one example, a UE may be barred from accessing one or more specific NTN cells if the UE does not implement network-verified location method(s). In this case, the UE is not allowed to camp on the network and shall not consider the cell(s) for cell selection or cell reselection.

In another example, a UE may be barred from accessing an entire PLMN (e.g. the UE is barred from accessing all NTN cells) if the UE does not implement the required UE network-verified location method(s).

In certain examples, UEs barred from accessing an entire PLMN, for example due to lack of capability to support network verification of UE location information, may attempt to access cells (and/or services) that belong to another PLMN (e.g. TN PLMN, or NTN PLMN), for example that do not apply a location verification requirement. This example may be applied in the case where the network does not allow any type of connections to be made, for example to a given PLMN, unless the UE location can potentially be verified.

In certain examples, certain service(s) may not be allowed if the UE is barred from accessing a cell, for example if the UE does not implement the required location verification method(s). In this case, in certain examples a UE may consider the cell to be an acceptable cell (3GPP TS 38.304), which means that a UE may use the cell to obtain one or more limited services, for example access emergency services (e.g. emergency calls), receive ETWS (Earthquake and Tsunami Warning System) and CMAS (Commercial Mobile Alert System) notifications, but not use the cell for other services, for example normal data services.

In certain examples, a NTN UE may consider an NTN cell as a suitable cell (e.g. the cell selection) or an acceptable cell, if this cell does not bar UEs without capabilities to support network verification of UE reported location information.

In certain examples, an NTN UE may not consider an NTN cell as a suitable cell or an acceptable cell, if this cell bars UEs without capabilities to support network verification of UE reported location information.

In certain examples, an NTN UE with capabilities to support network verification of UE reported location information may consider an NTN cell as a suitable cell or an acceptable cell.

In certain examples, an NTN and TN capable UE may consider access to TN cells, if the UE is barred from access to all neighbour NTN cells, for example based on any suitable barring condition including any of the barring conditions disclosed herein.

In certain examples, an indication about the services that are barred (and/or allowed) may be provided using any suitable signalling and/or message, for example SIB1, SIB19, a positioning SIB like positioning SIB1 or any other SIBs (System Information Blocks) related to a specific service. In certain examples, barring information may be communicated using dedicated RRC messages, for example RRC Release.

In certain examples, a UE may be allowed to access a cell, but certain aspects may be barred or limited for the UE without capabilities for UE verification of location service. For example, this may be based on distance-based cell reselection.

In certain examples, if barring is signalled, for example as described herein, then the UE may ignore the cellBarredNTN, which is the cell barring for Rel-17 NTN. This may allow the network to bar Rel-17 NTN UEs in a backwards compatible manner. The network may thus signal the barring for network-verified location methods, and may set cellBarredNTN to true. In this case, the Rel-17 NTN UE will see the cell as barred as it cannot read the Rel-18 related information elements.

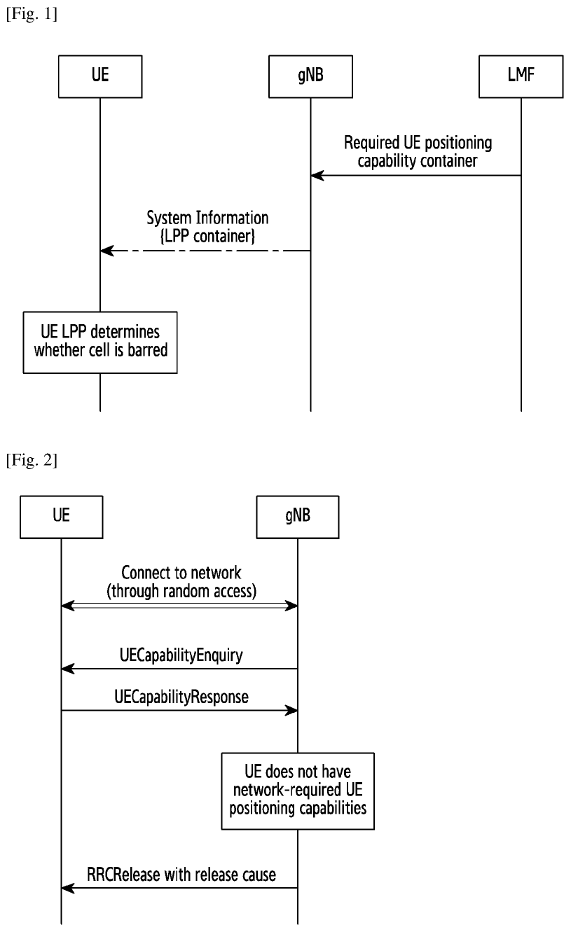

In certain examples, gNB may signal the required capabilities in any suitable manner, for example as a transparent container from either Core Network or LMF (or any other location server). In certain examples, the transparent container may contain the capabilities container from 3GPP TS 37.355, which may then be read by the corresponding UE LPP protocol. The gNB may thus not even be aware of the specific positioning needed to access the cell. In this case the UE LPP may read the required capabilities, and then that will determine whether the cell is considered as restricted (e.g. barring UE access as disclosed herein) or not. An example of this is illustrated in FIG. 1. The skilled person will appreciate that the signalling between gNB and LMF may also go through the AMF in certain examples.

### EXAMPLES

Example 1 of RRC signalling, where the UE needs to have implemented one of the positioning methods is only a single method for verifying the UE location:

Below, it is associated with 3GPP TS 38.331 V17.2.0.

```
- SIB1
SIB1 contains information relevant when evaluating if a UE is allowed to access a cell and defines the scheduling
of other system information. It also contains radio resource configuration information that is common for all UEs
and barring information applied to the unified access control.
  Signalling radio bearer: N/A
  RLS-SAP: TM
  Logical channels: BCCH
  Direction: Network to UE
SIB1 message
-- ASN1START
-- TAG-SIB1-START
```

| | |
|---|---|
| SIB1 ::= | SEQUENCE { |

| cellSelectionInfo | SEQUENCE { | |
|---|---|---|
| q-RxLevMin | Q-RxLevMin, | |
| q-RxLevMinoffset | INTEGER (1..8) | OPTIONAL, -- |

Need S

| | | |
|---|---|---|
| q-RxLevMinSUL | Q-RxLevMin | OPTIONAL, -- Need |

R

| | | |
|---|---|---|
| q-QualMin | Q-QualMin | OPTIONAL, -- Need |

S

| | | |
|---|---|---|
| q-QualMinOffset | INTEGER (1..8) | OPTIONAL -- |

Need S

| | | |
|---|---|---|
| } | OPTAIONAL, | -- Cond |

Standalone

| cellAccessRelatedInfo | CellAccessRelatedInfo, | |
|---|---|---|
| connEstFailureControl | ConnEstFailureControl | OPTIONAL, -- |

Need R

| | | |
|---|---|---|
| si-SchedulingInfo | SI-SchedulingInfo | OPTIONAL, -- |

Need R

| | | |
|---|---|---|
| servingCellConfigCommon | ServingCellConfigCommonSIB | OPTIONAL, -- |

Need R

| | | |
|---|---|---|
| ims-EmergencySupport | ENUMERATED {true} | OPTIONAL, -- |

Need R

| | | |
|---|---|---|
| eCallOverIMS-Support | ENUMERATED {true} | OPTIONAL, -- |

Need R

| | | |
|---|---|---|
| ue-TimersAndConstants | UE-TimersAndConstants | OPTIONAL, -- |

Need R

| uac-BarringInfo | SEQUENCE { | |
|---|---|---|
| uac-BarringForCommon | UAC-BarringPerCatList | OPTIONAL, -- |

Need S

| | | |
|---|---|---|
| uac-BarringPerPLMN-List | UAC-BarringPerPLMN-List | OPTIONAL, -- |

Need S

| | |
|---|---|
| uac-BarringInfoSetList | UAC-BarringInfoSetList, |

uac-AccessCategory1-SelectionAssistanceInfo CHOICE {

| | |
|---|---|
| plmnCommon | UAC-AccessCategory1- |

SelectionAssistanceInfo,

| | |
|---|---|
| individualPLMNList | SEQUENCE (SIZE (2..maxPLMN)) OF |

UAC-Accesscategory1-SelectionAssistanceInfo

| | |
|---|---|
| } | OPTIONAL, -- Need S |
| } | OPTIONAL, -- Need R |

| | | |
|---|---|---|
| useFullResumeID | ENUMERATED {true} | OPTIONAL, -- |

Need R

| | | |
|---|---|---|
| lateNonCriticalExtension | OCTET STRING | OPTIONAL, |
| nonCriticalExtension | SIB1-v1610-IES | OPTIONAL |

}
. . .

| | |
|---|---|
| SIB1-v1800-IEs ::= | SEQUENCE { |

```
    networkVerificationMethods-r18 SEQUENCE (SIZE
  (1..maxNetworkVerificationMethods)) OF NetworkVerificationMethod-r18
```

| | |
|---|---|
| OPTIONAL | -- Need S |

| | | |
|---|---|---|
| nonCriticalExtension | SEQUENCE { } | OPTIONAL |

}
NetworkVerificationMethod-r18 ::= ENUMERATED {OTDOA, A-GNSS, E-CID, TBS, other,
none}
. . .
-- TAG-SIB1-STOP
-- ASN1STOP

SIB1 field descriptions

...
networkVerificationBarring
Indicates the method that the UE need to have implemented in order to
not consider the network barred, see 38.304. If not present, the UE
considers the network not to be barred.
...

### Example 2 of Idle Mode Specification

Below, it is associated with 3GPP TS 38.304 V17.2.0.

### 5.3.1 Cell Status and Cell Reservations

Cell status and cell reservations are indicated in the MIB or SIB1 message as specified in TS 38.331 [3] by means of following fields:

cellBarred (IE Type: “Barred” or “not Barred”)
Indicated in MIB message. In case of multiple PLMNs or NPNs indicated in SIB1, this field is common for all PLMNs and NPNs. This field is ignored by UEs supporting NTN while cellBarredNIN is included in SIB1.
   cellBarredNTN (IE Type: “Barred” or “not Barred”)
Indicated in SIB1 message. In case of multiple PLMNs indicated in SIB1, this field is common for all PLMNs. This field is ignored if the UE does not support NTN connectivity.
   cellBarredRedCap1Rx (IE Type: “Barred” or “not Barred”)
Indicated in SIB1 message. In case of multiple PLMNs or NPNs indicated in SIB1, this field is common for all PLMNs and NPNs. This field is only applicable to RedCap UEs.
   cellBarredRedCap2Rx (IE Type: “Barred” or “not Barred”)
Indicated in SIB1 message. In case of multiple PLMNs or NPNs indicated in SIB1, this field is common for all PLMNs and NPNs. This field is only applicable to RedCap UEs.
   cellReservedForOperator Use (IE Type: “Reserved” or “not Reserved”)
Indicated in SIB1 message. In case of multiple PLMNs or NPNs indicated in SIB1, this field is specified per PLMN or per SNPN.
   cellReservedForOtherUse (IE Type: “True”)
Indicated in SIB1 message. In case of multiple PLMNs indicated in SIB1, this field is common for all PLMNs.
   cellReservedForFutureUse (IE Type: “True”)
Indicated in SIB1 message. In case of multiple PLMNs or NPNs indicated in SIB1, this field is common for all PLMNs and NPNs.
NOTE 0: IAB-MT ignores the cellBarred, cellReservedForOperatorUse, cellReservedForFutureUse, and intraFreqReselection (i.e. treats intraFreqReselection as if it was set to allowed) as defined in TS 38.331 [3]. IAB-MT also ignores cellReservedForOtherUse for cell barring determination (i.e. NPN capable IAB-MT considers cellReservedForOtherUse for determination of an NPN-only cell) as defined in TS 38.331 [3].

### Iab-Support (IE Type: “True”)

Indicated in SIB1 message. In case of multiple PLMNs or NPNs indicated in SIB1, this field is specified per PLMN or per SNPN.
networkVerificationMethods (IE type “OTDOA”, “A-GNSS”, “E-CID”, “TBS”, “other”, “none”) Indicated in SIB1. In case of multiple PLMNs or NPNs indicated in SIB1, this field is specified per PLMN or per SNPN.

When networkVerificationMethods is broadcast in this cell,
UE considers the cell to be barred if none of the positioning methods are supported. See 38.305 and 37.355 for positioning methods
UE ignores cellBarredNTN

As another example where the transparent UE LPP capability is signalled in SIB1:

Below, it is associated with 3GPP TS 38.331 V17.2.0. [133]

```
- SIB1
SIB1 contains information relevant when evaluating if a UE is allowed to access a cell and defines the scheduling
of other system information. It also contains radio resource configuration information that is common for all UEs
and barring information applied to the unified access control.
  Signalling radio bearer: N/A
  RLC-SAP: TM
  Logical channels: BCCH
  Direction: Network to UE
SIB1 message
-- ASN1START
-- TAG-SIB1-START
```

| | |
|---|---|
| SIB1 ::= | SEQUENCE { |

| cellSelectionInfo | SEQUENCE { | |
|---|---|---|
| q-RxLevMin | Q-RxLevMin, | |
| q-RxLevMinOffset | INTEGER (1..8) | OPTIONAL, -- Need S |
| q-RxLevMinSUL | Q-RxLevMin | OPTIONAL, -- Need R |
| q-QualMin | Q-QualMin | OPTIONAL, -- Need S |
| q-QualMinOffset | INTEGER (1..8) | OPTIONAL -- Need S |

| | | |
|---|---|---|
| } | OPTIONAL, | -- Cond Standalone |

| cellAccessRelatedInfo | CellAccessRelatedInfo, | |
|---|---|---|
| connEstFailureControl | ConnEstFailureControl | OPTIONAL, -- Need R |
| si-SchedulingInfo | SI-SchedulingInfo | OPTIONAL, -- Need R |

| | | |
|---|---|---|
| ServingCellContigCommon | ServingCellContigCommonSIB | OPTIONAL, -- Need R |

| | | |
|---|---|---|
| ims-EmergencySupport | ENUMERATED {true} | OPTIONAL, -- Need R |
| eCallOverIMS-Support | ENUMERATED {true} | OPTIONAL, -- Need R |
| ue-TimersAndConstants | UE-TimersAndConstants | OPTIONAL, -- Need R |

| uac-BarringInfo | SEQUENCE { | |
|---|---|---|
| uac-BarringForCommon | UAC-BarringPerCatList | OPTIONAL, -- Need S |
| uac-BarringPerPLMN-List | UAC-BarringPerPLMN-List | OPTIONAL, -- Need S |

| | |
|---|---|
| uac-BarringInfoSetList | UAC-BarringInfoSetList, |

uac-AccessCategory1-SelectionAssistanceInfo CHOICE {

| | |
|---|---|
| plmnCommon | UAC-AccessCategory1-SelectionAssistanceInfo, |

| | |
|---|---|
| individualPLMNList | SEQUENCE (SIZE (2..maxPLMN)) OF UAC- |

AccessCategoryl-SelectionAssistanceInfo

| | |
|---|---|
| } | OPTIONAL -- Need S |
| } | OPTIONAL, -- Need R |

| | | |
|---|---|---|
| useFullResumeID | ENUMERATED {true} | OPTIONAL, -- Need R |
| lateNonCriticalExtension | OCTET STRING | OPTIONAL, |
| nonCriticalExtension | SIB1-v1610-IES | OPTIONAL |

}
. . .

| | |
|---|---|
| SIB1-v1800-IEs ::= | SEQUENCE { |

| | | |
|---|---|---|
| networkVerificationCapabilities-r18 | OCTET STRING | OPTIONAL, |

-- Need S

| | | |
|---|---|---|
| nonCriticalExtension | SEQUENCE { } | OPTIONAL |

}
. . .
-- TAG-SIB1-STOP
-- ASN1STOP

SIB1 field descriptions

...
networkVerificationCapabilities
Container of LPP positioning capaibilites (provideCapabilities, 37.355
clause 6.3) indicating the method that the UE need to have implemented
in order to not consider the network barred, see 38.304. If not present, the
UE considers the network not to be barred.
...

### 2. RAN-Based Rejection

In certain examples, instead of entirely barring the UE, the UE may be rejected while trying to establish connection to the gNB or the Core Network. For example, this may be useful for cases in which the PLMNs and/or cells are established across multiple countries, which is expected to be common for NTN access.

In certain examples, UE may inform gNB whether it has the capability to support network verification of UE location information. For example, this information may be included in the UECapability response, or any other suitable message or signalling.

In certain examples, if the UE indicates that it is not capable of supporting network verified UE location information, the gNB may release the RRC connection with a specific cause value. An example of this technique is illustrated in FIG. 2.

In certain examples, if a UE does not support verification of UE location information, by the network, the gNB may keep that UE in RRC_INACTIVE state, for example by sending RRCRelease with suspend indication. In certain examples, the gNB may include a release with redirect indication (e.g. to TN PLMN or TN cells, or NTN PLMN/cells with no location verification requirements). In certain examples, the gNB may include information (e.g. an indication) to the UEs to de-prioritize NTN connection (NTN frequency, PLMN, or cells).

In certain examples, if supported, the gNB may trigger the UE context release procedure, for example by sending UE Context Release request message to the AMF to initiate the UE context release procedure. In certain examples, the gNB may include a cause value (e.g. an existing or a new defined cause value) indicating the reason of UE context release (e.g. Network Verification Not Supported, Location Verification Not Supported, or any other suitable naming).

In certain examples, the gNB may indicate that the UE may only have access to limited services, for example due to its capabilities. For example, this may be done by the gNB not establishing any more than certain a number of Radio Bearers (e.g. only establishing Signalling Radio Bearers (SRBs) and no Data Radio Bearers (DRBs)).

In certain examples, if a UE receives a Reject of Release, for example due to not having implemented the required positioning techniques, the UE may search for other networks.

### 3. Core Network-Based Rejection

In certain examples, the UE may inform the core network (e.g. AMF) about its capability to support network verification of UE location information, for example through NAS messages (e.g. Registration Request message). The AMF may inform the gNB about whether the UE has this capability, for example through NGAP messages (e.g. NGAP: UE Context setup request message) and/or any other suitable messages.

In certain examples, if the procedure for network verification of UE location information has failed, AMF may inform gNB through NGAP messages (e.g. NGAP: UE Context setup request message) and/or any other suitable messages. The gNB may release the RRC connection on receipt of this information.

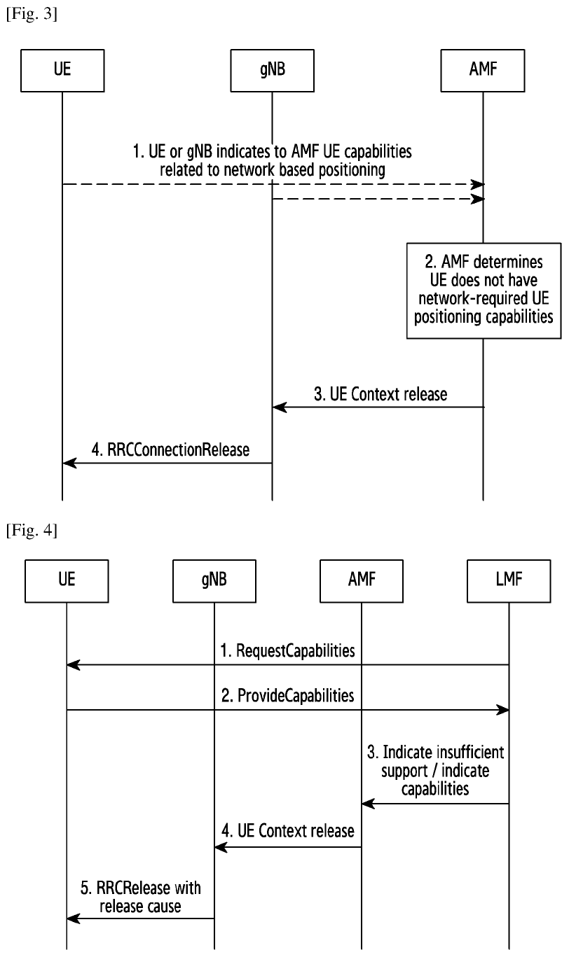

In certain examples, when the capability indicates no support for network verification of UE location information (e.g. provided in NAS message or RRC message), AMF may fail one or more NAS procedure, for example an initial registration procedure or PDU Session setup procedure. An example of this technique is illustrated in FIG. 3.

In certain examples, AMF may provide a different set of accepted NSSAI (Network Slice Selection Assistance Information) and rejected NSSAI for a UE not supporting UE verified network location, or a UE that has failed a procedure for network verification of UE location information.

In certain examples, AMF may release one or more PDU Sessions if the procedure for network verification of UE location information fails.

In certain examples, the AMF may modify the UE context at the gNB such that the maximum Bit rate allowable is reduced if the UE does not have sufficient positioning capabilities. For example, this may be done through the UE Context Modification (3GPP TS 38.413 V17.2.0) sent by the AMF to the gNB.

In certain examples, if the gNB receives an indication that the UE does not support network verification of UE location information, for example through the RRC capability information sent by the UE, or through the NGAP message in the AMF (if the UE has provided a NAS capability to the AMF for the network verification of UE location information), or if the procedure for network verification of UE location information has failed, then gNB may not configure the UE for distance-based cell reselection or distance-based connected mode mobility.

In certain examples, a UE may skip performing location-based (and/or distance-based) cell reselection, if the procedure for network verification of UE location information fails. In certain examples, the UE may skip performing distance-based connected mode mobility, if the UE is not capable of supporting network verification of UE location information or if the procedure for network verification of UE location information has failed.

In certain examples, the UE positioning capabilities may be acquired by AMF from LMF (Location Management Function), which in turn may have received UE positioning capabilities from UE. If the required capabilities are not supported, the LMF may signal this to the AMF, which may then reject the UE. An example of this technique is illustrated in FIG. 4.

### Other Examples on Cell Access

In certain examples, the network may provide a list of NTN cells to a UE to attempt access for NTN services. The list may include any suitable information, for example cell ID (Identity/Identification) and/or whether or not cell access requires the UE capability to support network verified UE location. In certain examples, the list may be provided for the serving and/or neighbour cells using any suitable signalling or messages, for example existing (or newly defined) dedicated RRC and/or NAS signalling, and/or using system information broadcast (e.g. periodically and/or ondemand).

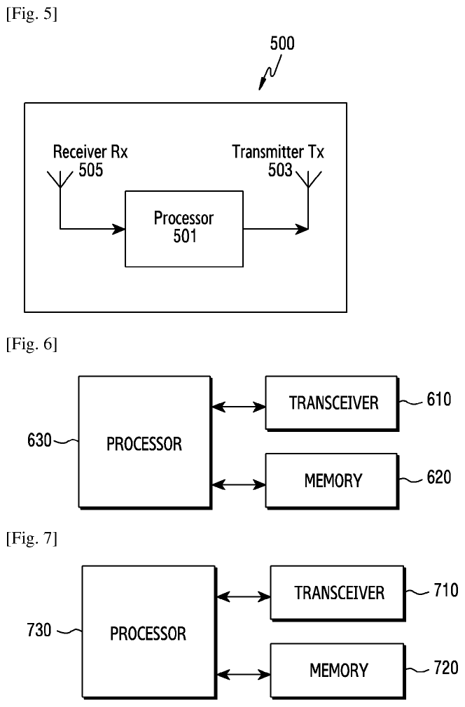

FIG. 5 is a block diagram of an exemplary network entity that may be used in examples of the present disclosure. For example, a UE and/or gNB in the examples of FIGS. 1-4 may comprise an entity of FIG. 5. The skilled person will appreciate that a network entity may be implemented, for example, as a network element on a dedicated hardware, as a software instance running on a dedicated hardware, and/or as a virtualised function instantiated on an appropriate platform, e.g. on a cloud infrastructure.

The entity 500 comprises a processor (or controller) 501, a transmitter 503 and a receiver 505. The receiver 505 is configured for receiving one or more messages from one or more other network entities, for example as described above. The transmitter 503 is configured for transmitting one or more messages to one or more other network entities, for example as described above. The processor 501 is configured for performing one or more operations, for example according to the operations as described above.

FIG. 6 illustrates a block diagram illustrating a structure of a UE according to an embodiment of the disclosure.

As shown in FIG. 6, the UE according to an embodiment may include a transceiver 610, a memory 620, and a processor 630. The transceiver 610, the memory 620, and the processor 630 of the UE may operate according to a communication method of the UE described above. However, the components of the UE are not limited thereto. For example, the UE may include more or fewer components than those described above. In addition, the processor 630, the transceiver 610, and the memory 620 may be implemented as a single chip. Also, the processor 630 may include at least one processor or at least one controller.

The transceiver 610 collectively refers to a UE receiver and a UE transmitter, and may transmit/receive a signal to/from a base station or a network entity. The signal transmitted or received to or from the base station or a network entity may include control information and data. The transceiver 610 may include a RF transmitter for upconverting and amplifying a frequency of a transmitted signal, and a RF receiver for amplifying low-noise and down-converting a frequency of a received signal. However, this is only an example of the transceiver 610 and components of the transceiver 610 are not limited to the RF transmitter and the RF receiver.

Also, the transceiver 610 may receive and output, to the processor 630, a signal through a wireless channel, and transmit a signal output from the processor 630 through the wireless channel.

The memory 620 may store a program and data required for operations of the UE. Also, the memory 620 may store control information or data included in a signal obtained by the UE. The memory 620 may be a storage medium, such as read-only memory (ROM), random access memory (RAM), a hard disk, a CD-ROM, and a DVD, or a combination of storage media.

The processor 630 may control a series of processes such that the UE operates as described above. For example, the transceiver 610 may receive a data signal including a control signal transmitted by the base station or the network entity, and the processor 630 may determine a result of receiving the control signal and the data signal transmitted by the base station or the network entity.

FIG. 7 illustrates a block diagram illustrating a structure of a base station according to an embodiment of the disclosure.

As shown in FIG. 7, the base station according to an embodiment may include a transceiver 710, a memory 720, and a processor 730. The transceiver 710, the memory 720, and the processor 730 of the base station may operate according to a communication method of the base station described above. However, the components of the base station are not limited thereto. For example, the base station may include more or fewer components than those described above. In addition, the processor 730, the transceiver 710, and the memory 720 may be implemented as a single chip. Also, the processor 730 may include at least one processor at least one controller.

The transceiver 710 collectively refers to a base station receiver and a base station transmitter, and may transmit/receive a signal to/from a terminal or a network entity. The signal transmitted or received to or from the terminal or a network entity may include control information and data. The transceiver 710 may include a RF transmitter for up-converting and amplifying a frequency of a transmitted signal, and a RF receiver for amplifying low-noise and down-converting a frequency of a received signal. However, this is only an example of the transceiver 710 and components of the transceiver 710 are not limited to the RF transmitter and the RF receiver.

Also, the transceiver 710 may receive and output, to the processor 730, a signal through a wireless channel, and transmit a signal output from the processor 730 through the wireless channel.

The memory 720 may store a program and data required for operations of the base station. Also, the memory 720 may store control information or data included in a signal obtained by the base station. The memory 720 may be a storage medium, such as read-only memory (ROM), random access memory (RAM), a hard disk, a CD-ROM, and a DVD, or a combination of storage media.

The processor 730 may control a series of processes such that the base station operates as described above. For example, the transceiver 710 may receive a data signal including a control signal transmitted by the terminal, and the processor 730 may determine a result of receiving the control signal and the data signal transmitted by the terminal.

The techniques described herein may be implemented using any suitably configured apparatus and/or system. Such an apparatus and/or system may be configured to perform a method according to any aspect, embodiment, example or claim disclosed herein. Such an apparatus may comprise one or more elements, for example one or more of receivers, transmitters, transceivers, processors, controllers, modules, units, and the like, each element configured to perform one or more corresponding processes, operations and/or method steps for implementing the techniques described herein. For example, an operation/function of X may be performed by a module configured to perform X (or an X-module). The one or more elements may be implemented in the form of hardware, software, or any combination of hardware and software.

It will be appreciated that examples of the present disclosure may be implemented in the form of hardware, software or any combination of hardware and software. Any such software may be stored in the form of volatile or non-volatile storage, for example a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape or the like.

It will be appreciated that the storage devices and storage media are embodiments of machine-readable storage that are suitable for storing a program or programs comprising instructions that, when executed, implement certain examples of the present disclosure. Accordingly, certain examples provide a program comprising code for implementing a method, apparatus or system according to any example, embodiment, aspect and/or claim disclosed herein, and/or a machine-readable storage storing such a program. Still further, such programs may be conveyed electronically via any medium, for example a communication signal carried over a wired or wireless connection.

Certain examples of the present disclosure provide a base station configured to perform a method according to any aspect, example, embodiment or claim disclosed herein.

Certain examples of the present disclosure provide a UE configured to perform a method according to any aspect, example, embodiment or claim disclosed herein.

Certain examples of the present disclosure provide a network (or wireless communication system) comprising a base station and a UE according to any aspects, examples, embodiments or claims disclosed herein.

Certain examples of the present disclosure provide a computer program comprising instructions which, when the program is executed by a computer or processor, cause the computer or processor to carry out a method according to any aspect, example, embodiment or claim disclosed herein.

Certain examples of the present disclosure provide a computer or processor-readable data carrier having stored thereon a computer program according any aspect, example, embodiment or claim disclosed herein.

While the invention has been shown and described with reference to certain examples, it will be understood by those skilled in the art that various changes in form and detail may be made therein without departing from the scope of the invention, as defined by the appended claims.

1. A user equipment (UE) in a wireless communication system, the UE comprising:
a transceiver; and
a controller coupled with the transceiver, and configured to:
transmit, to a base station, capability information indicating whether the UE supports a network verified UE location in a non-terrestrial network (NTN), and
in case that the UE does not support the network verified UE location or a verification is not completed, identify a rejection of an access to at least one service for the UE.

2. The UE of claim 1,
wherein the at least one service is associated with the NTN.

3. The UE of claim 1,
wherein the rejection is triggered by releasing a connection between the UE and the base station.

4. The UE of claim 1,
wherein the rejection is triggered by releasing a connection between the UE and a core network.

5. A base station in a wireless communication system, the base station comprising:
a transceiver; and
a controller coupled with the transceiver, and configured to:
receive, from a user equipment (UE), capability information indicating whether the UE supports a network verified UE location in a nonterrestrial network (NTN), and
in case that the UE does not support the network verified UE location or a verification is not completed, identify a rejection of an access to at least one service for the UE.

6. The base station of claim 5,
wherein the at least one service is associated with the NTN.

7. The base station of claim 5,
wherein the rejection is triggered by releasing a connection between the UE and the base station.

8. The base station of claim 5,
wherein the rejection is triggered by releasing a connection between the UE and a core network.

9. A method performed by a user equipment (UE) in a wireless communication system, the method comprising:
transmitting, to a base station, capability information indicating whether the UE supports a network verified UE location in a nonterrestrial network (NTN); and
in case that the UE does not support the network verified UE location or a verification is not completed, identifying a rejection of an access to at least one service for the UE.

10. The method of claim 9,
wherein the at least one service is associated with the NTN.

11. The method of claim 9,
wherein the rejection is triggered by releasing a connection between the UE and the base station.

12. The method of claim 9,
wherein the rejection is triggered by releasing a connection between the UE and a core network.

13. A method performed by a base station in a wireless communication system, the method comprising:
receiving, from a user equipment (UE), capability information indicating whether the UE supports a network verified UE location in a non-terrestrial network (NTN); and
in case that the UE does not support the network verified UE location or a verification is not completed, identify a rejection of an access to at least one service for the UE.

14. The method of claim 13,
wherein the at least one service is associated with the NTN.

15. The method of claim 13,
wherein the rejection is triggered by releasing a connection between the UE and the base station.
